(19) United States
(12) Patent Application Publication
(10) Pub. No.: US 2023/0311114 A1
(43) Pub. Date: Oct. 5, 2023

(54) CARTRIDGE AND LIQUID HANDLING SYSTEM

(71) Applicant: Enplas Corporation, Saitama (JP)

(72) Inventor: Nobuya SUNAGA, Saitama (JP)

(73) Assignee: Enplas Corporation, Saitama (JP)

(21) Appl. No.: 18/127,092

(22) Filed: Mar. 28, 2023

(30) Foreign Application Priority Data
Mar. 30, 2022 (JP) 2022-056294

(51) Int. Cl. B01L 3/00

(52) U.S. Cl. CPC B01L 3/502; B01L 2400/0481; B01L 2300/123; B01L 2200/04

(57) ABSTRACT

A cartridge for supplying a liquid to a channel chip is provided, and the cartridge includes the following: a main body including a liquid housing part and an elastic communication pipe for allowing a liquid housed in the liquid housing part to pass therethrough; and a pressing member configured to be able to switch a pressing state of the pressing member to the communication pipe in order to switch the communication pipe between a closed state and an opened state.

### CROSS REFERENCE TO RELATED APPLICATIONS

This application claims the benefit of priority of Japanese Patent Application No. 2022-056294, filed on Mar. 30, 2022, the disclosure of which including the specification, drawings and abstract is incorporated herein by reference in its entirety.

### TECHNICAL FIELD

The present invention relates to a cartridge and a liquid handling system.

### BACKGROUND ART

In recent years, microwell plates, channel chips, and the like are used to analyze, for example, cells, proteins, and nucleic acids. Microwell plates and channel chips are advantageous such that only a small amount of reagents and samples is required for analysis, thus are expected to be used in a variety of applications such as clinical tests, food tests, and environment tests

Patent Literature (hereinafter, referred to as PTL) 1, for example, discloses a reaction container including a sample container for housing a sample, a sample container housing part for housing the sample container, and a sample channel connected to the sample container housed in the sample container housing part. The sample container includes a plurality of locking grooves on the surface thereof, and the sample container housing part includes a plurality of locking claws. By engaging the locking claws with the locking grooves, the sample container housing part holds the sample container at a predetermined position.

### CITATION LIST

### Patent Literature

PTL 1
WO2009/072332

### SUMMARY OF INVENTION

### Technical Problem

Regarding the reaction container (cartridge) described in PTL 1, the sample container is not configured to be detached from the sample container housing part.

An object of the present invention is to provide a cartridge configured to be detachable. Another object of the present invention is to provide a liquid handling system including the cartridge.

### Solution to Problem

A cartridge of the present invention is for supplying a liquid to a channel chip. The cartridge includes a main body including a liquid housing part and a communication pipe for allowing a liquid housed in the liquid housing part to pass therethrough, the communication pipe being elastic; and a pressing member configured to allow switching of a pressing state of the pressing member to the communication pipe in order to switch the communication pipe between a closed state and an opened state.

A liquid handling system of the present invention includes the cartridge, a channel chip configured to be connected to the communication pipe of the cartridge; and a chip holder housing the channel chip.

### Advantageous Effects of Invention

The present invention is capable of providing a cartridge configured to be detachable. The present invention is also capable of providing a liquid handling system including the cartridge.

### BRIEF DESCRIPTION OF DRAWINGS

FIG. 1A a plan view of a liquid handling system according to an embodiment of the present invention, and FIG. 1B is a schematic cross-sectional view taken along line B-B in FIG. 1A;

FIG. 2A is a perspective view, FIG. 2B is a front view, FIG. 2C is a plan view, FIG. 2D is a bottom view, and FIG. 2E is a side view all illustrating a main body;

FIG. 3A is a perspective view, FIG. 3B is a front view, FIG. 3C is a plan view, FIG. 3D is a bottom view, and FIG. 3E is a side view all illustrating a pressing member;

FIG. 4A is a cross-sectional view illustrating a channel chip and rotary members, and

FIG. 4B is a bottom view illustrating the channel chip;

FIGS. 5A and 5B illustrate the operation of the liquid handling system; and

FIG. 6A is a cross-sectional view illustrating a closed state, and FIG. 6B is a cross-sectional view illustrating an opened state.

### DESCRIPTION OF EMBODIMENTS

Hereinafter, liquid handling system 100 according to an embodiment of the present invention will be described.

Configuration of Liquid Handling System

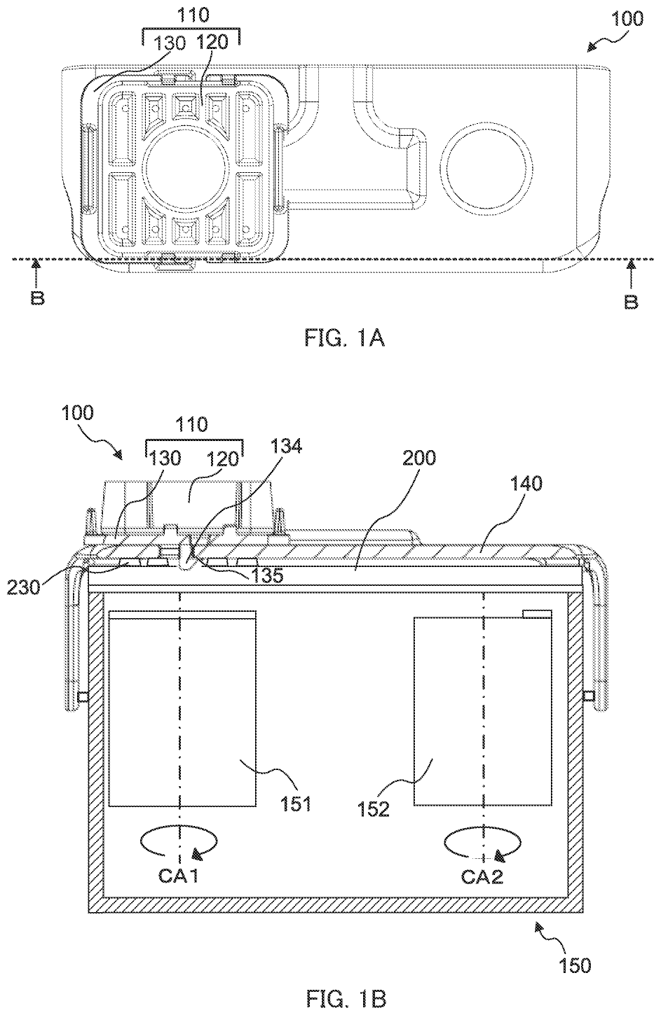

FIG. 1A is a plan view of liquid handling system 100. FIG. 1B is a cross-sectional view of liquid handling system 100 taken along line B-B in FIG. 1A.

As illustrated in FIGS. 1A and 1B, liquid handling system 100 includes channel chip 200, chip holder 140 for housing channel chip 200, cartridge 110 housing a liquid to be introduced into channel chip 200, and liquid handling device 150. Liquid handling device 150 is for supporting chip holder 140 and for controlling the flow of the liquid in channel chip 200 housed in chip holder 140. Cartridge 110 includes pressing member 130 and main body 120 housing a liquid to be introduced into channel chip 200. Liquid handling device 150 includes first rotary member 151 and second rotary member 152. First rotary member 151 is for pressing the diaphragm of a membrane valve of channel chip 200 housed in chip holder 140, and second rotary member 152 is for pressing the diaphragm of a membrane pump.

For easier understanding of the configuration of liquid handling system 100, some components are omitted, and channel chip 200 and rotary members (first rotary member 151 and second rotary member 152) are illustrated separately in FIG. 1B.

The liquid housed in main body 120 is introduced into channel chip 200 held by chip holder 140. This introduction of the liquid is controlled by pressing with pressing member 130 disposed between main body 120 and channel chip 200. The rotation of a rotary member controls movement of the liquid introduced into channel chip 200. The rotation of a rotary member enables various operations on the liquid subjected to the control in channel chip 200.

Configuration of Chip Holder

Chip holder 140 houses below described channel chip 200 and is disposed in liquid handling device 150 at a predetermined position.

Chip holder 140 includes a through hole on the top surface thereof for allowing the insertion of communication pipe 122 of main body 120.

Chip holder 140 is configured to allow first rotary member 151 and second rotary member 152 to contact the bottom surface of channel chip 200 when chip holder 140 holds channel chip 200.

Configuration of Cartridge

As described above, cartridge 110 includes main body 120 and pressing member 130.

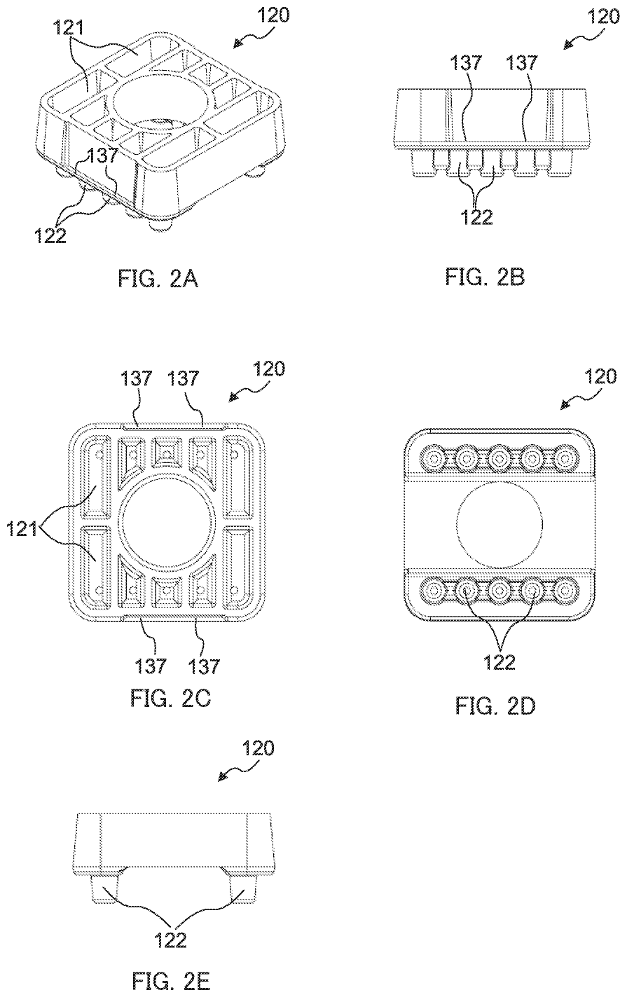

FIG. 2A is a perspective view of main body 120. FIG. 2B is a front view of main body 120. FIG. 2C is a plan view of main body 120. FIG. 2D is a bottom view of main body 120. FIG. 2E is a side view of main body 120.

Main body 120 includes liquid housing parts 121 and communication pipes 122. In liquid handling system 100, cartridge 110 is disposed on or above channel chip 200 and supply a liquid to channel chip 200.

The configuration of liquid housing part 121 is not limited as long liquid housing part 121 can house a liquid. In the present embodiment, liquid housing part 121 has a substantially rectangular parallelepiped shape, and a plurality of liquid housing parts 121 are in the main body.

Communication pipe 122 opens to liquid housing part 121 and serves as a passage for a liquid in liquid housing part 121. Communication pipe 122 extends downward from the bottom of the cartridge. Communication pipe 122 is elastic. Due to the elasticity, communication pipe 122 narrows when pressed by below described pressing member 130, thus is closed. In the present embodiment, main body 120 is integrally molded from an elastic material; thus communication pipe 122 is also elastic. The number of communication pipes 122 is more than one corresponding to the number of liquid housing parts 121. Liquid housing part 121 may be disposed at any appropriate position corresponding to the position where well 230 serving as the inlet of channel chip 200 is disposed.

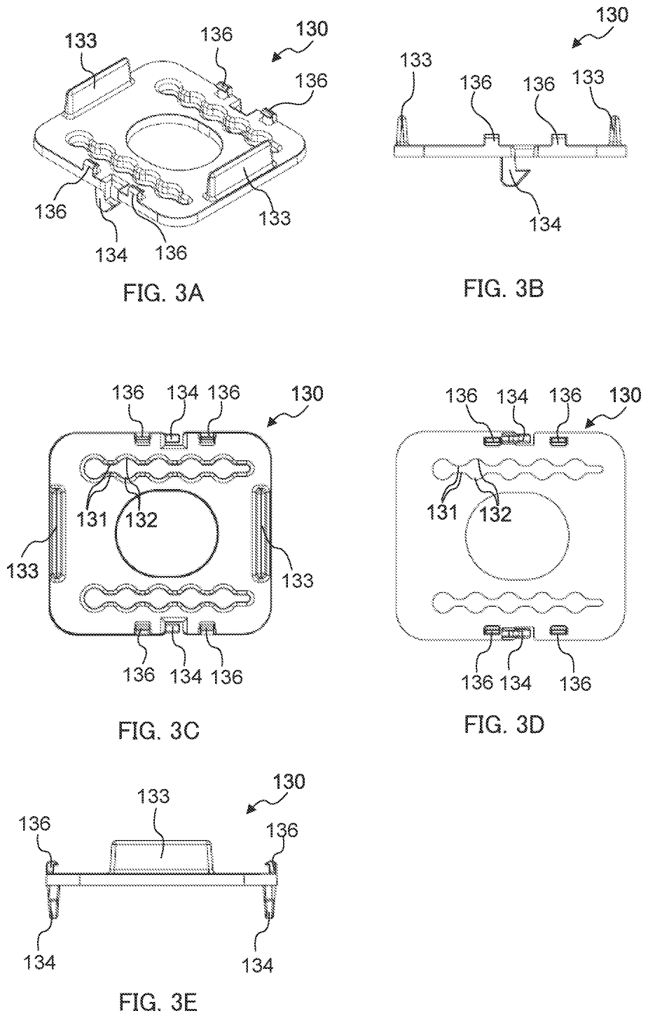

FIG. 3A is a perspective view of pressing member 130. FIG. 3B is a front view of pressing member 130. FIG. 3C is a plan view of pressing member 130. FIG. 3D is a bottom view of pressing member 130. FIG. 3E is a side view of pressing member 130.

Pressing member 130 includes first pressing parts 131, second pressing parts 132, knobs 133, first engaging parts 134, and third engaging parts 136.

In the present embodiment, first pressing part 131 and second pressing part 132 of pressing member 130 are configured in such a way that portions of each pressing part can sandwich communication pipe 122 therebetween. As illustrated in FIG. 3C, the distance between the portions of first pressing part 131 is smaller than the distance between the portions of second pressing part 132. When communication pipe 122 is sandwiched between the portions of first pressing parts 131, communication pipe is thus in a closed state. On the other hand, when communication pipe 122 is sandwiched between the portions of second pressing parts 132, communication pipe is thus in an opened state. Specifically, in the closed state, elastic communication pipe 122 is pressed hard to be deformed by first pressing part 131, so that communication pipe 122 is closed. In addition, in the present embodiment, communication pipe 122 can be positioned on inlet (well 230) of channel chip 200 in both the opened state and the closed state. That is, it is possible to switch between the opened state and the closed state without changing the position of main body 120 with respect to channel chip 200.

In the present embodiment as described above, pressing member 130 is configured to be able to switch the pressing state of the pressing member to communication pipe 122 in order to switch the communication pipe between the closed state and the opened state. In the present embodiment, first pressing part 131 and second pressing part 132 are arranged side by side to form an inner wall of one through hole (slit), thereby allowing switching of the state. More specifically, five pairs each composed of one second pressing part and one first pressing part are arranged in a row in the present embodiment. As a result, these pairs form one elongated through hole (slit). The above example describes first pressing part 131 and second pressing part 132 formed as a through hole (slit); however, first pressing part 131 and second pressing part 132 may be formed as a notch (a structure in which one longitudinal end of the slit is open to the outside).

Pressing member 130 is preferably made of a material having enough rigidity such that communication pipe 122 can be closed when first pressing part 131 presses communication pipe 122.

Knob 133 is used when moving pressing member 130 with respect to main body 120 so as to switch between the closed state and the opened state. In the present embodiment, knob 133 is a protrusion extending in a direction perpendicular to the direction in which first pressing parts 131 and second pressing parts 132 are arranged, as illustrated in FIG. 3C.

First engaging part 134 is configured to engage with second engaging part 135 disposed on a member other than cartridge 110 to fix cartridge 110. In the present embodiment, first engaging part 134 is a structure projecting from the bottom of pressing member 130. In addition, in the present embodiment, first engaging part 134 includes a claw and engages with second engaging part 135 (which is a flat structure). The location where first engaging part 134 engages, that is, the location of second engaging part 135 is not limited as long as first engaging part 134 can engage. Second engaging part 135 may be disposed at any location, for example, on channel chip 200, chip holder 140, or liquid handling device 150. In the present embodiment, second engaging part 135 is disposed on the bottom surface of the upper lid of chip holder 140 covering channel chip 200, and first engaging part 134 is engaged with second engaging part 135 when communication pipe 122 is in the opened state, as illustrated in FIG. 1B.

In addition, in the present embodiment, two first engaging parts 134 are disposed respectively at both ends of pressing member 130 in the direction perpendicular to the direction in which first pressing parts 131 and second pressing parts 132 are arranged, as illustrated in FIG. 3C.

In the above description, first engaging part 134 includes a claw and second engaging part 135 is flat; however, the relationship may be reversed. That is, first engaging part 134 may be flat and second engaging part 135 may include a claw. Second engaging part 135 may be disposed at any location also in this case, for example, on channel chip 200, chip holder 140, or liquid handling device 150.

Further, the shapes of first engaging part 134 and second engaging part 135 are not limited to the structure with a claw and the flat structure as long as the engaging parts can engage with each other. Such an engageable shape may be appropriately selected from known engagement structures.

Third engaging part 136 is configured to engage with fourth engaging part 137 disposed on main body 120 to prevent main body 120 from coming off pressing member 130. In the present embodiment, third engaging part 136 is a structure projecting from the top surface of pressing member 130. In addition, in the present embodiment, third engaging part 136 includes a claw and engages with fourth engaging part 137 (which is flat).

Configuration of Channel Chip

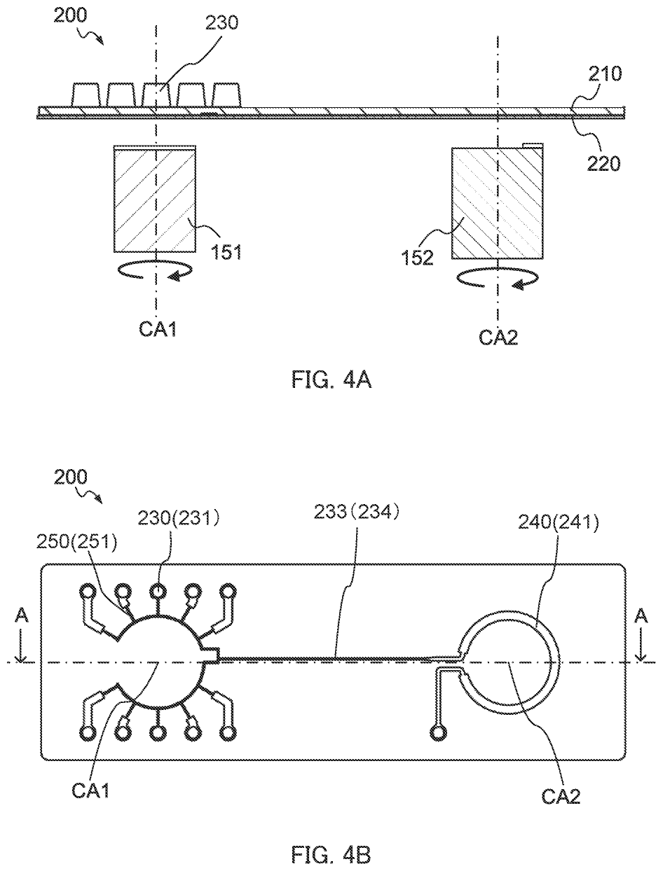

FIG. 4A is a cross-sectional view illustrating the configuration of channel chip 200 and rotary members. FIG. 4B is a bottom view of channel chip 200. The cross-sectional view of FIG. 4A is taken along line A-A of FIG. 4B.

First rotary member 151 is rotated about first central axis CA1 by an external drive mechanism (not illustrated). Second rotary member 152 is rotated about second central axis CA2 by an external drive mechanism (not illustrated). Channel chip 200 includes substrate 210 and film 220 and is installed in such a way that film 220 contacts first rotary member 151 and second rotary member 152. For easier understanding of the configuration, components are illustrated separately from each other in FIG. 4A.

As described above, channel chip 200 includes substrate 210 and film 220 (see FIG. 4A). Groove 234, arcuate groove 241, arcuate groove 251, and through holes 231 are formed in substrate 210. Groove 234 is configured to become channel 233, groove 241 is configured to become arcuate rotary membrane pump 240, rotary membrane valves 250 are configured to be disposed at groove 251, and through hole 231 becomes an inlet or outlet (well 230).

Film 220 is joined to one surface of substrate 210 so as to block openings of grooves 234, 241, 251 and through holes 231 formed in substrate 210. Groove 234 of substrate 210 blocked by film 220 becomes channel 233 for allowing a fluid, such as a reagent, a liquid sample, a washing liquid, a gas, or a powder, to flow therethrough. Arcuate groove 241 blocked by film 220 becomes rotary membrane pump 240 for moving a fluid. Radially extending grooves, where rotary membrane valves 250 are disposed, are connected to arcuate groove 251 blocked by film 220. Film 220 blocking arcuate groove 241 functions as a diaphragm of rotary membrane pump 240. Through hole 231 blocked by film 220 becomes well 230. Well 230 is used as an inlet for introducing a fluid or an outlet for taking out a fluid. Well 230 serving as an inlet communicates with communication pipe 122 of main body 120, thereby introducing a liquid.

Operation

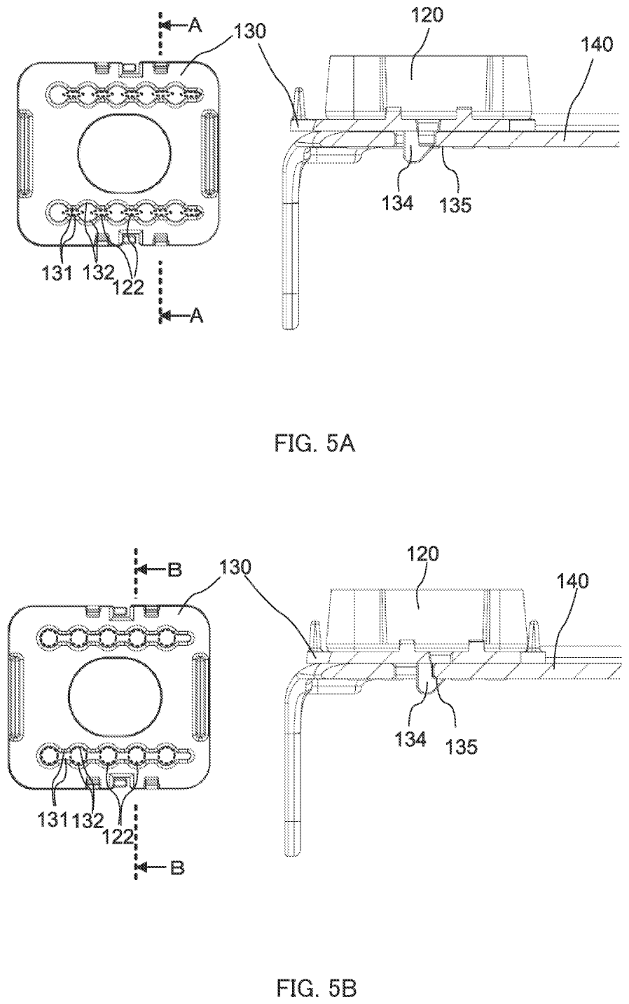

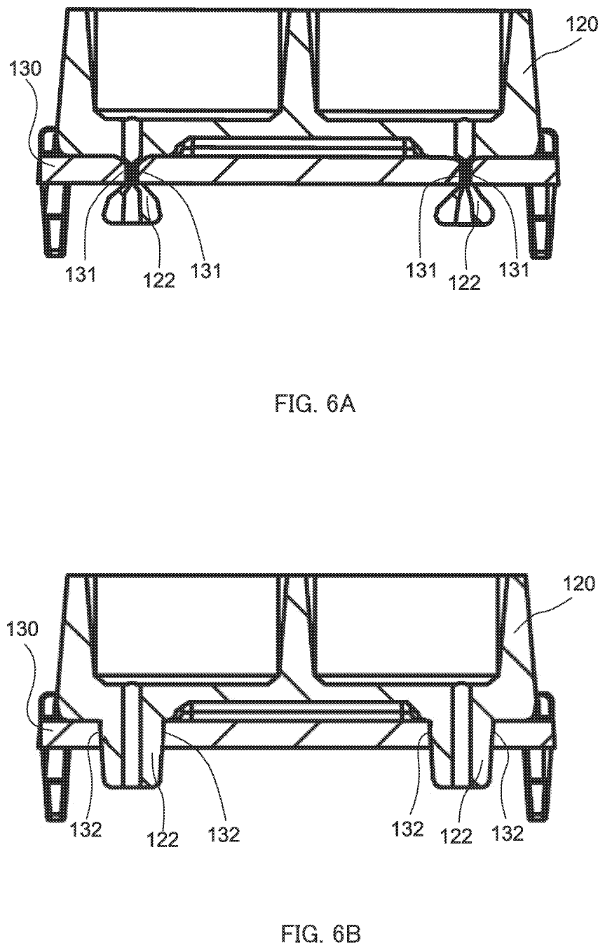

FIGS. 5A and 5B illustrate the operation of liquid handling system 100. FIG. 5A illustrates communication pipes 122 in the closed state, and FIG. 5B illustrates communication pipes 122 in the opened state. FIGS. 5A and 5B omit channel chip 200. FIG. 6A is a cross-sectional view taken along line A-A of FIG. 5A, and FIG. 6B is a cross-sectional view taken along line B-B of FIG. 5B.

Specifically, the left diagram of FIG. 5A and FIG. 6A illustrate a state in which each communication pipe 122 is sandwiched between the portions of first pressing part 131 and closed. The right diagram of FIG. 5A illustrates the position of pressing member 130 with respect to main body 120 and chip holder 140 in this state.

In a similar manner, the left diagram of FIG. 5B and FIG. 6B illustrate a state in which each communication pipe 122 is opened inside second pressing part 132. The right diagram of FIG. 5B illustrates the position of pressing member 130 with respect to main body 120 and chip holder 140 in this state. It is possible to switch between the pressing state of FIG. 5A and the pressing state of FIG. 5B.

As illustrated in FIG. 5A, when communication pipe 122 is in the closed state, first engaging part 134 does not engage with second engaging part 135. Therefore, in the closed state, cartridge 110 can be attached to or detached from chip holder 140 and channel chip 200. In addition, the liquid in liquid housing part 121 does not leak out from communication pipe 122 in the closed state, which enables easy handling of cartridge 110. It is thus easy to attach and detach cartridge 110.

In the state in which cartridge 110 is attached to channel chip 200 housed in chip holder 140 as illustrated in FIG. 5A, pressing member 130 is moved relative to main body 120 and chip holder 140 as illustrated in FIG. 5B. More specifically, pressing member 130 is slid in the direction in which first pressing parts 131 and second pressing parts 132 are arranged (rightward in FIG. 5B) with respect to main body 120 fixed to channel chip 200. First engaging part 134 is thus engaged with second engaging part 135 to fix cartridge 110 to chip holder 140 and channel chip 200. In addition, communication pipe 122 moves into second pressing part 132 and is opened. As a result, the liquid in liquid housing part 121 can be introduced into channel chip 200 through communication pipe 122 at any time.

The method for moving pressing member 130 relative to main body 120 is not limited to the above configuration. As another example, pressing member 130 may be fixed and main body 120 may be moved. Alternatively, both pressing member 130 and main body 120 may be moved.

Effect

Cartridge 110 according to the embodiment of the present invention can switch communication pipe 122 for supplying a liquid to channel chip 200 between a closed state and an opened state. Along with the switching between the closed state and the opened state, cartridge 110 can be switched between a non-fixed state (detachable state) and a fixed state with respect to chip holder 140 (channel chip 200).

### INDUSTRIAL APPLICABILITY

Cartridges and liquid handling systems of the present invention are particularly advantageous in a variety of applications such as clinical tests, food tests, and environment tests.

### REFERENCE SIGNS LIST

100 Liquid handling system
110 Cartridge
120 Main body
121 Liquid housing part
122 Communication pipe
130 Pressing member
131 First pressing part
132 Second pressing part
133 Knob
134 First engaging part
135 Second engaging part
136 Third engaging part
137 Fourth engaging part
140 Chip holder
150 Liquid handling device
151 First rotary member
152 Second rotary member
200 Channel chip
210 Substrate
220 Film
230 Well
231 Through hole
233 Channel
234, 241, 251 Groove
240 Rotary membrane pump
250 Rotary membrane valve

1. A cartridge for supplying a liquid to a channel chip, the cartridge comprising:
a main body including a liquid housing part and a communication pipe for allowing a liquid housed in the liquid housing part to pass therethrough, the communication pipe being elastic; and
a pressing member configured to allow switching of a pressing state of the pressing member to the communication pipe in order to switch the communication pipe between a closed state and an opened state.

2. The cartridge according to claim 1, wherein:
the pressing member includes a first pressing part and a second pressing part, the first pressing part sandwiching the communication pipe between portions thereof when bringing the communication pipe to the closed state, the second pressing part sandwiching the communication pipe between portions thereof when bringing the communication pipe to the opened state; and
a distance between the portions of the first pressing part is smaller than a distance between the portions of the second pressing part.

3. The cartridge according to claim 2, wherein the pressing member is configured to switch between a state in which the communication pipe is positioned within the first pressing part and a state in which the communication pipe is positioned within the second pressing part by moving the main body and the pressing member relative to each other.

4. The cartridge according to claim 1, wherein the liquid housing part and the communication pipe are integrally molded as a product of an elastic material.

5. The cartridge according to claim 1, wherein the pressing member further includes a first engaging part for engaging with a second engaging part of one of a channel chip, a chip holder, and a liquid handling device, the channel chip being a channel chip with which the communication pipe of the cartridge is configured to be connected, the chip holder being for housing the channel chip, and the liquid handling device being for supporting the channel chip or the chip holder.

6. The cartridge according to claim 5, wherein the first engaging part does not engage with the second engaging part when the pressing member brings the communication pipe to the closed state, and engages with the second engaging part when the pressing member brings the communication pipe to the opened state.

7. A liquid handling system, comprising:
the cartridge according to claim 1;
a channel chip configured to be connected with the communication pipe of the cartridge; and
a chip holder housing the channel chip.
